(19) United States
(12) Patent Application Publication
(10) Pub. No.: US 2003/0044606 A1
(43) Pub. Date: Mar. 6, 2003

(54) Adhesive and cable using same

(76) Inventor: Suzette Iskander, Huntersville, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 09/939,956

(22) Filed: Aug. 27, 2001

(51) Int. Cl. H01B 7/18; D02G 3/00

(52) U.S. Cl. 428/375; 174/107

(57) ABSTRACT

The present invention is an adhesive that can be used to bond a cable jacket to an outer conductor to produce an excellent bond peel strength and that also allows the jacket to be separated from the outer conductor to produce a residue that can easily be removed from the outer conductor. The adhesive includes polyethylene, a copolymer derived from ethylene and at least one monomer selected from the group consisting of acrylic acid, methacrylic acid, methyl acrylate and ethyl acrylate; and a resin derived from at least one unsaturated C5 hydrocarbon monomer. The adhesive preferably further includes a hindered phenolic antioxidant. The present invention further includes cables and particularly coaxial cables that include this adhesive composition.

### FIELD OF THE INVENTION

The present invention relates to adhesives and more particularly to adhesives for bonding cable jackets and outer conductors that allow the jacket and the conductor to be separated leaving a residue on the surface of the outer conductor that can be easily removed.

### BACKGROUND OF THE INVENTION

Cables such as coaxial cables are used in a variety of applications for transmitting electricity, signals, and the like. In particular, coaxial cables are used to transmit RF signals such as cable television signals, cellular telephone signals, and even internet and other data signals, to a subscriber. The RF signals are typically transmitted over long distances using trunk and distribution cable and drop cables are used as the final link in bringing the signals from the trunk and distribution cable to the subscriber.

Trunk and distribution cable and drop cable generally include a center conductor, a dielectric layer, an outer conductor and a jacket that protects the cable. Typically, the jacket is adhesively bonded to the outer conductor to prevent moisture that enters the cable during installation from travelling along the interface of the cable between the outer conductor and the jacket and corroding the outer conductor along this interface. Furthermore, the adhesive between the outer conductor and jacket improves the bending properties of cables, particularly cables including smooth-walled outer conductors, by stabilizing the outer conductor in bending to prevent the outer conductor from buckling.

One particularly useful adhesive material for use in bonding the jacket and the outer conductor comprises a blend of a low density polyethylene and an ethylene-acrylic acid copolymer. Although this material provides a strong bond between the jacket and the outer conductor, the peel strength for this material is inconsistent. In particular, when the jacket is peeled from the outer conductor for connectorization, the adhesive often experiences cohesive failure and an adhesive residue (e.g. in the form of spots) is left on the surface of the outer conductor that is difficult to remove, even using various cleaning solvents. This residue on the surface of the outer conductor can cause the coaxial cable to be improperly mated with the connector and thus can affect the electrical performance of the cable. Therefore, there is a need in the art to produce an adhesive that provides a consistent peel strength so that any adhesive residue that remains on the conductor surface when the jacket is peeled away can be easily removed.

### SUMMARY OF THE INVENTION

The present invention provides an adhesive that can be used to bond a cable jacket to a conductor that provides a consistent peel strength and that produces a residue on the outer conductor that can be easily removed when the jacket is separated from the outer conductor for connectorization purposes. The adhesive of the invention includes polyethylene, a copolymer derived from ethylene and at least one monomer selected from the group consisting of acrylic acid, methacrylic acid, methyl acrylate and ethyl acrylate; and a resin derived from at least one unsaturated C5 hydrocarbon monomer. In addition, the adhesive preferably further includes a hindered phenolic antioxidant.

It has been unexpectedly discovered that the adhesive composition of the invention produces a bond between a metal surface and a polymeric surface that not only has excellent bond strength but that also produces a residue that can be easily removed when the metal surface and the polymeric surface are separated. In particular, as discussed above, one problem with the LDPE/EAA copolymer adhesives traditionally used with coaxial cables is that the EAA copolymer produces too aggressive a bond and the metal and polymer interfaces bonded with the adhesive when separated produce a residue on the metal surface that is difficult to remove. It would be expected that this problem would be exacerbated by the addition of a tackifying resin that increases the aggressiveness or tackiness of the adhesive. However, it has been unexpectedly discovered that the addition of a tackifying resin derived from unsaturated C5 hydrocarbon monomers to the adhesive composition provides an adhesive that leaves a residue that can be easily removed from the metal surface. Furthermore, coaxial cables using the adhesive composition of the invention between the outer conductor and protective jacket have increased peel strengths and better bending properties than cables using conventional adhesive compositions. Moreover, the adhesive of the invention provides the increased peel strength over a wide range of temperatures (e.g. −20° F. to 160° F.).

In a preferred embodiment of the invention, the resin used in the adhesive is derived from unsaturated C5 hydrocarbon monomers. The resin is preferably derived from at least one monomer selected from the group consisting of piperylene, 2-methyl-2-butene, isoprene, cyclopentene, cyclopentadiene, and dimers thereof. The resin can be an aliphatic resin or can aromatically modified, e.g., by using an aromatic monomer such as α-methyl styrene in the formation of the resin. The ethylene used in the formulation preferably includes a low density polyethylene and the copolymer is preferably an ethylene-acrylic acid copolymer. Preferably, the polyethylene is present in an amount from about 80 to about 95 percent by weight, the copolymer is present in an amount from about 3 to about 5 percent by weight, the resin is present in an amount from about 0.2 to about 15 percent by weight, and the hindered phenolic antioxidant is present in an amount from 0 to about 1.0 percent by weight.

The present invention further includes a cable comprising a metal conductor, a polymeric jacket surrounding the metal conductor; and the adhesive described above bonding the outer conductor and the polymer jacket. The adhesive forms an adhesive bond between said outer conductor and said polymeric jacket having a 72 hour bond peel strength of greater than or equal to about 3 lb_{f}/in and less than or equal to about 20 lb_{f}/in. Preferably, for 1⅝ inch coaxial cable, the 72 hour bond peel strength is greater than about 5 lb_{f}/in. When the jacket is removed from the outer conductor for connectorization, a light residue remains on the surface of the outer conductor that can be easily removed using an adhesive pad. Preferably, the metal conductor is formed of copper or a copper alloy and the polymeric jacket is formed of polyethylene. In a particularly preferred embodiment, the cable is a coaxial cable comprising an inner conductor, a dielectric layer surrounding the inner conductor, an outer conductor surrounding the dielectric layer, a polymeric jacket surrounding the outer conductor, and the adhesive described above bonds the outer conductor and the polymer jacket.

These and other features and advantages of the present invention will become more readily apparent to those skilled in the art upon consideration of the following detailed description and accompanying drawings, which describe both the preferred and alternative embodiments of the present invention.

### BRIEF DESCRIPTION OF THE DRAWINGS

FIG. 1 is a perspective view of a coaxial cable according to one embodiment of the invention that includes a longitudinally-welded outer sheath.

FIG. 2 is a perspective view of a coaxial cable according to another embodiment of the invention that includes a laminate tape and a braid.

FIG. 3 is a perspective view of a coaxial cable according to yet another embodiment of the invention that includes a laminate tape and helically arranged wires around the laminate tape.

FIGS. 4A and 4B schematically illustrate a method of making a coaxial cable corresponding to the embodiment of the invention illustrated in FIG. 1.

FIG. 5 is a schematic illustration of a method of making a coaxial cable corresponding to the embodiment of the invention illustrated in FIGS. 2 and 3.

### DETAILED DESCRIPTION OF THE PREFERRED EMBODIMENTS

In the drawings and the following detailed description, preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description and accompanying drawings. In the drawings, like numbers refer to like elements throughout.

The adhesive of the present invention includes polyethylene, a copolymer derived from ethylene and at least one monomer selected from the group consisting of acrylic acid, methacrylic acid, methyl acrylate and ethyl acrylate; and a resin derived from at least one unsaturated Cs hydrocarbon monomer. In addition, the adhesive preferably further includes a hindered phenolic antioxidant.

The polyethylene used in the adhesive of the invention can be in the form of low density polyethylene (LDPE), linear low density polyethylene (LLDPE), medium density polyethylene (MDPE), high density polyethylene (HDPE), and blends thereof. Preferably, the polyethylene includes low density polyethylene. The polyethylene can be added separately to the adhesive and/or it can be added in a masterbatch with the ethylene copolymer as discussed in more detail below. The polyethylene is present in the adhesive in a total amount from about 80 to about 95 percent by weight, more preferably from about 90 to about 95 percent by weight.

The adhesive further includes an ethylene copolymer derived from ethylene and at least one monomer selected from the group consisting of acrylic acid, methacrylic acid, methyl acrylate and ethyl acrylate. The ethylene copolymer is typically an ethylene-acrylic acid (EAA) copolymer derived from monomers comprising ethylene monomers and acrylic acid monomers. Preferably, the ethylene copolymer is provided in a masterbatch comprising the ethylene copolymer (e.g., the ethylene-acrylic acid (EAA) copolymer) and polyethylene (e.g. LDPE). A particularly useful EAA copolymer is PRIMACOR® 3330 adhesive polymer commercially available from Dow Chemical and derived from 93.5 percent by weight of polyethylene and 6.5 percent by weight of EAA copolymer. The ethylene copolymer is present in the adhesive of the invention in an amount from about 3 to about 5 percent by weight and when a masterbatch is used such as PRIMACOR® 3330, a sufficient amount of the masterbatch is added to provide a percentage of the ethylene copolymer within this range.

The adhesive of the invention further includes a resin derived from at least one unsaturated C5 hydrocarbon monomer. These resins are commercially available under the WINGTACK® mark from Goodyear Tire & Rubber Company. Preferably, the resin is derived from at least one monomer selected from the group consisting of piperylene, 2-methyl-2-butene, isoprene, cyclopentene, cyclopentadiene, and dimers thereof. In a preferred embodiment of the invention, the resin used in the adhesive is an aliphatic C5 hydrocarbon resin, an aromatically modified C5 hydrocarbon resin, or a blend thereof. Preferably, the resin is an aromatically modified C5 hydrocarbon resin such as WINGTACK® Extra resin. WINGTACK® Extra resin is derived from a proprietary combination of monomers including piperylene, 2-methyl-2-butene and α-methyl styrene. Alternatively, the resin can be an aliphatic C5 hydrocarbon resin such as WINGTACK® 95 resin, a diene-olefin copolymer of piperylene and 2-methyl-2-butene having a ring and ball softening point of about 95° C. and prepared by the cationic polymerization of 55% piperylene, 8% cyclopentene, 35% 2-methyl-2-butene and 2% 2-pentene. The resins used in the invention normally have ring and ball softening points between about 80° C. and about 115° C. In addition to the resins mentioned above, other modified C5 hydrocarbon resins such as WINGTACK® Plus resin and WINGTACK® 86 resin can be used in the present invention. The resin is present in the adhesive in an amount from about 0.2 to about 15 percent by weight, more preferably from about 1 to about 5 percent by weight.

In addition to the above components, the adhesive can include a free flowing antioxidant to prevent degradation of the adhesive. Preferably, the antioxidant is a hindered phenolic antioxidant. The antioxidant preferably has a molecular weight of at least about 500 g/mole, more preferably, at least about 1000 g/mole. A particularly suitable antioxidant is IRGANOX® 1010, commercially available from Ciba Specialty Chemicals. The antioxidant is preferably present in the adhesive in an amount from 0 to about 1.0 percent by weight, more preferably from about 0.2 to about 0.8 percent by weight.

The adhesive of the invention can be used to produce a bond between a metal surface and a polymeric surface that has good bond strength. In addition, the adhesive of the invention also allows the metal surface and polymeric surface to be separated while leaving the metal surface substantially free of adhesive residue. This is an unexpected property of the adhesive of the invention. In particular, as discussed above, conventional LDPE and EAA copolymer adhesives traditionally have produced too aggressive a bond and the metal and polymer interfaces bonded with the adhesive when separated produced a residue on the metal surface that was difficult to remove. The addition of a C5 hydrocarbon tackifying resin to the adhesive composition would not be expected to provide an adhesive that would allow the metal surface and the polymeric surface to be separated to produce a residue on the metal surface that can be easily removed. Specifically, when the polymeric surface is separated from the metal surface, there is failure within the adhesive itself and a residue in the form of a fog is produced on the metal surface. This residue can be easily removed by an abrasive pad such as a SCOTCH-BRITE™ pad from 3M Co. without the need to use cleaning solvents.

The adhesive of the invention has found particular use with cables that include a metal conductor and a surrounding polymer jacket and more particularly with coaxial cable wherein the metal conductor is the outer conductor and the polymer jacket surrounds the outer conductor. The adhesive cable can be used with trunk or distribution cable or other cable designs that include a continuous outer conductor adjacent the polymeric jacket but can also be used with cable designs where the outer conductor adjacent the polymeric jacket is non-continuous, e.g., a drop cable that includes a braid adjacent the polymeric jacket. The adhesive can also be used to bond other metal/polymer interfaces such as the interface between the inner conductor and surrounding dielectric layer or the interface between the dielectric and the surrounding outer conductor.

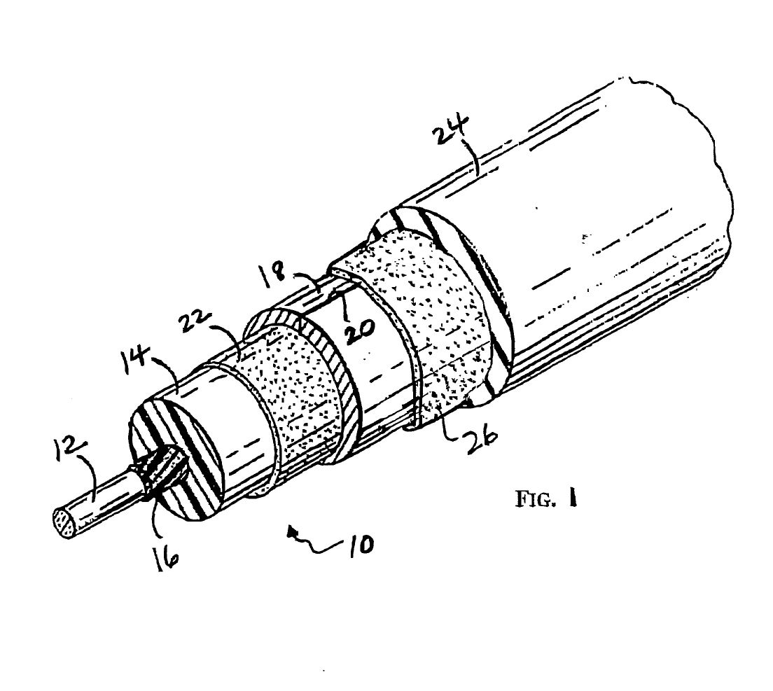

In accordance with a preferred embodiment of the invention, FIG. 1 illustrates a coaxial cable 10 of the type typically used as trunk and distribution cable. The coaxial cable 10 is generally used for the long distance transmission of RF signals such as cable television signals, cellular telephone signals, internet, data and the like. Typically, the cable 10 illustrated in FIG. 1 has a diameter of between about 0.3 and about 2.0 inches when used as trunk and distribution cable.

As illustrated in FIG. 1, the coaxial cable 10 comprises a center conductor 12 of a suitable electrically conductive material and a surrounding dielectric layer 14. The center conductor 12 is preferably formed of copper, copper-clad aluminum, copper-clad steel, or aluminum. In addition, as illustrated in FIG. 1, the center conductor 12 is typically a solid conductor. Nevertheless, the center conductor 12 can also be a hollow tube and can further include a supporting material within the tube as described in coassigned and copending U.S. application Ser. No. 09/485,656, filed Feb. 14, 2000. In the embodiment illustrated in FIG. 1, only a single center conductor 12 is shown, as this is the most common arrangement for coaxial cables of the type used for transmitting RF signals. However, it would be understood by those skilled in the art that the present invention is also applicable to coaxial cables having more than one conductor in the center of the cable 10.

A dielectric layer 14 surrounds the center conductor 12. The dielectric layer 14 is a low loss dielectric formed of a suitable plastic such as polyethylene, polypropylene or polystyrene. Preferably, to reduce the mass of the dielectric per unit length and thus the dielectric constant, the dielectric material is an expanded cellular foam composition, and in particular, a closed cell foam composition is preferred because of its resistance to moisture transmission. The dielectric layer 14 is preferably a continuous cylindrical wall of expanded foam plastic dielectric material and is more preferably a foamed polyethylene, e.g., high-density polyethylene. Although the dielectric layer 14 of the invention generally consists of a foam material having a generally uniform density, the dielectric layer 14 may have a gradient or graduated density such that the density of the dielectric increases radially from the center conductor 12 to the outside surface of the dielectric layer, either in a continuous or a step-wise fashion. For example, a foam-solid laminate dielectric can be used wherein the dielectric 14 comprises a low-density foam dielectric layer surrounded by a solid dielectric layer. These constructions can be used to enhance the compressive strength and bending properties of the cable and permit reduced densities as low as 0.10 g/cc along the center conductor 12. The lower density of the foam dielectric 14 along the center conductor 12 enhances the velocity of RF signal propagation and reduces signal attenuation.

The cable 10 can optionally include a thin polymeric layer 16. The thin polymeric layer 16 can be a corrosion-inhibiting layer or it can be an adhesive layer. The corrosion-exhibiting layer can include a polymeric material (e.g. polyethylene) and a corrosion-inhibiting compound (e.g. a benzotriazole compound such as BTA). Alternatively, the thin polymeric layer can include an adhesive composition such as a LDPE/EAA copolymer composition or the adhesive composition of the invention.

Closely surrounding the dielectric layer 14 is an outer conductor 18. In the embodiment illustrated in FIG. 1, the outer conductor 18 is a tubular metallic sheath. The outer conductor 18 can be formed of aluminum or an aluminum alloy but is preferably formed of copper or a copper alloy. In the case of trunk and distribution cable, the outer conductor 18 is preferably both mechanically and electrically continuous to allow the outer conductor 18 to mechanically and electrically seal the cable from outside influences as well as to prevent the leakage of RF radiation. However, the outer conductor 18 can be perforated to allow controlled leakage of RF energy for certain specialized radiating cable applications. The outer conductor 18 is preferably a thin walled copper sheath having a wall thickness selected so as to maintain a T/D ratio (ratio of wall thickness to outer diameter) of less than 1.6 percent. Although the outer conductor 18 can be corrugated, it is preferably smooth-walled. The smooth-walled construction optimizes the geometry of the cable to reduce contact resistance and variability of the cable when connectorized and to eliminate signal leakage at the connector.

In the embodiment illustrated in FIG. 1, the outer conductor 18 is preferably made from a copper strip that is formed into a tubular configuration with the opposing side edges butted together, and with the butted edges continuously joined by a continuous longitudinal weld, indicated at 20. Nevertheless, other materials such as an aluminum strip can be used in place of the copper strip. While production of the outer conductor 18 by longitudinal welding has been illustrated as preferred for this embodiment, persons skilled in the art will recognize that other methods for producing a mechanically and electrically continuous thin walled tubular copper sheath could also be employed such as overlapping the longitudinal edges of the copper strip.

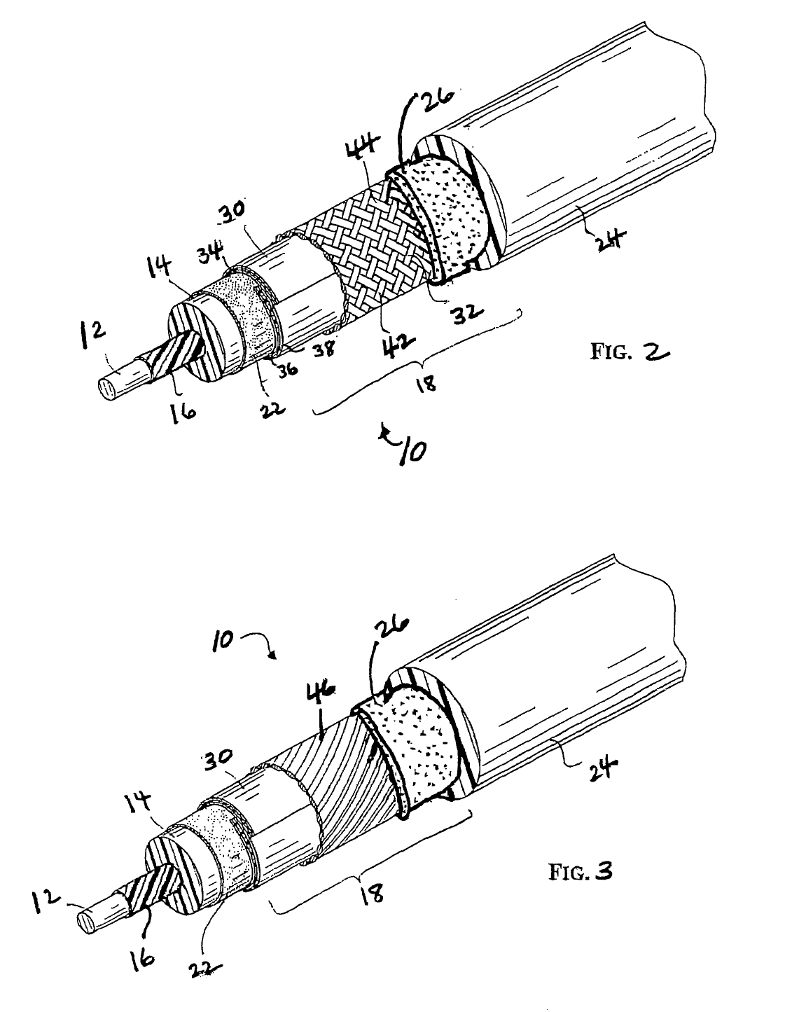

In addition to being a tubular metallic sheath, the outer conductor 18 can be formed of other materials. For example, in the case of drop cable as illustrated in FIG. 2, the outer conductor 18 can be formed of a laminated shielding tape 30 that extends longitudinally along the cable 10 and a metal braid 32 that surrounds the shielding tape. The shielding tape 30 can be longitudinally applied such that the edges of the shielding tape are either in abutting relationship or are overlapping to provide 100% shielding coverage. More preferably, the longitudinal edges of the shielding tape 30 are overlapped. The shielding tape 30 includes at least one conductive layer such as a thin metallic foil layer. Preferably, the shielding tape is a bonded laminate tape including a polymer layer 34 with metal layers 36 and 38 bonded to opposite sides of the polymer layer. The polymer layer 34 is preferably a polyolefin (e.g. polypropylene) or a polyester film and the metal layers 36 and 38 are preferably thin aluminum foil layers. To prevent cracking of the aluminum in bending, the aluminum foil layers 36 and 38 can be formed of an aluminum alloy having generally the same tensile and elongation properties as the polymer layer 34.

The metal braid 32 illustrated in FIG. 2 is formed by interlacing a first plurality of elongate aluminum wires 42 and a second plurality of elongate aluminum wires 44. Preferably, the braid 32 uses 34 AWG aluminum braid wires. The braid 32 preferably covers a substantial portion of the shielding tape 30, e.g., greater than 40% of the shielding tape, and more preferably greater than 65%, to increase the shielding of the outer conductor 18.

As an alternative to forming a braid 32, a plurality of elongate aluminum wires 46 can be helically arranged around the underlying laminate tape 30 as shown in FIG. 3. A second plurality of elongate aluminum strands (not shown) can also surround the plurality of elongate wires 46, preferably having an opposite helical orientation than the elongate wires, e.g., a counterclockwise orientation as opposed to a clockwise orientation. Like the braid wires 42 and 44, the elongate wires 46 are preferably AWG aluminum braid wire and preferably cover a substantial portion of the shielding tape 30, e.g., greater than 40% of the shielding tape, and more preferably greater than 65%, to increase the shielding of the outer conductor 18.

The inner surface of the outer conductor 18 (in any of the embodiments of FIGS. 1-3) is preferably continuously bonded throughout its length and throughout its circumferential extent to the outer surface of the dielectric layer 14 by a thin layer of adhesive 22 (e.g. less than 5 mils) using a LDPE/EAA adhesive and more preferably the adhesive of the invention.

As shown in FIG. 1, a protective jacket 24 surrounds the outer conductor 18. Suitable compositions for the outer protective jacket 24 include thermoplastic coating materials such as polyethylene, polyvinyl chloride, polyurethane and rubbers. Preferably, the jacket 24 is formed of polyethylene. Although the jacket 24 illustrated in FIG. 1 consists of only one layer of material, laminated multiple jacket layers may also be employed to improve toughness, strippability, burn resistance, the reduction of smoke generation, ultraviolet and weatherability resistance, protection against rodent gnaw through, strength resistance, chemical resistance and/or cut-through resistance.

In accordance with the invention, an adhesive layer 26 is provided between the outer conductor 18 and the jacket 24. Preferably, the adhesive layer 26 is applied at a thickness from about 0.5 to about 10 mils, more preferably between about 1 and about 5 mils. As discussed above, the adhesive layer 26 of the invention is used between the outer conductor 18 and the jacket 24 to provide a strong adhesive bond between the outer conductor and jacket. Furthermore, the adhesive layer 26 allows the jacket 24 to be peeled away from the outer conductor 18 such that any residue remaining on the outer conductor can be easily removed. Therefore, the adhesive layer 26 between the jacket 24 and the outer conductor 18 addresses the problem typically associated with LDPE/EAA adhesives in that the jacket can be separated from the outer conductor without leaving a difficult to remove adhesive residue on the outer conductor.

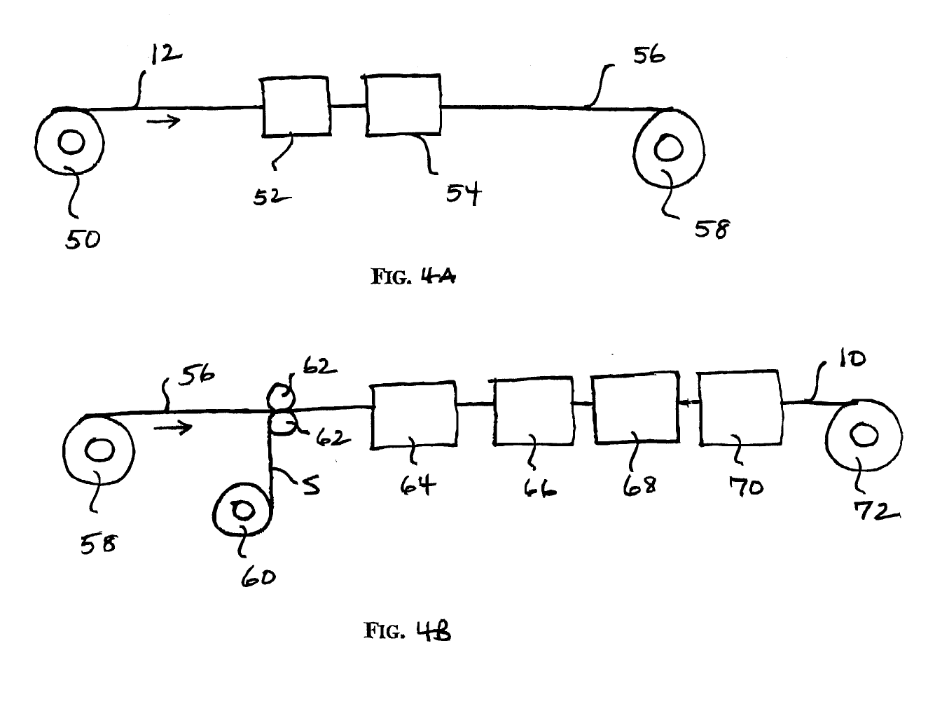

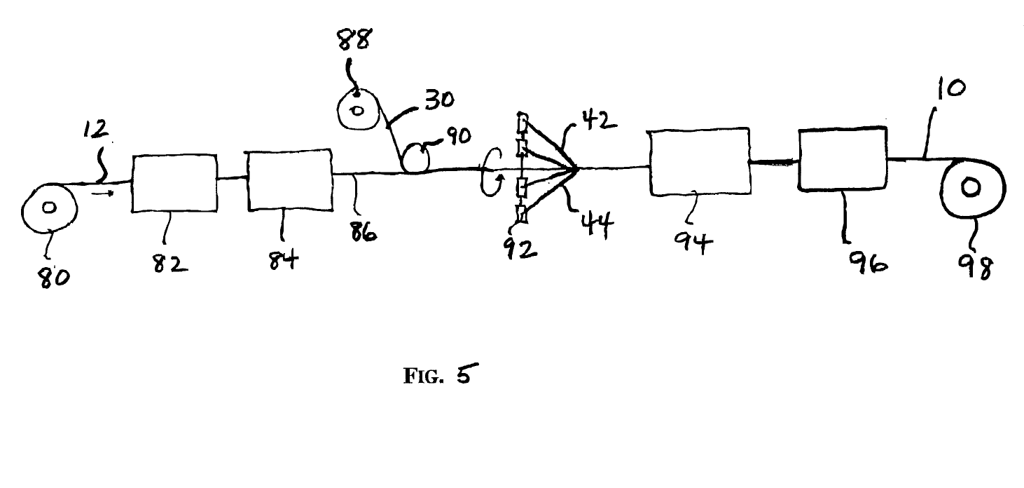

FIGS. 4A and 4B illustrate a method of making the cable 10 of the invention illustrated in FIG. 1. As illustrated in FIG. 4A, the center conductor 12 is directed from a suitable supply source, such as a reel 50, along a predetermined path of travel (from left to right in FIG. 4A). In order to produce a coaxial cable having a continuous center conductor 12, the terminal edge of the center conductor from one reel is mated with the initial edge of the center conductor from a subsequent reel and welded together. It is important in forming a continuous cable to weld the center conductors from different reels without adversely affecting the surface characteristics and therefore the electrical properties of the center conductor 12.

The center conductor 12 is preferably advanced to a suitable apparatus 52 such as an extruder apparatus 52 or spraying apparatus and is coated with a polymeric material to form the thin polymeric layer 16. The coated center conductor 12 is then advanced to an extruder apparatus 54 that continuously applies a foamable polymer composition concentrically around the coated center conductor. Preferably, high-density polyethylene and low-density polyethylene are combined with nucleating agents in the extruder apparatus 54 to form the polymer melt. Upon leaving the extruder 54, the foamable polymer composition foams and expands to form a dielectric layer 14 around the center conductor 12.

In addition to the foamable polymer composition, an adhesive composition is preferably coextruded with the foamable polymer composition around the center conductor to form adhesive layer 22. Extruder apparatus 54 continuously extrudes the adhesive composition concentrically around the polymer melt to form an adhesive coated core 56. Although coextrusion of the adhesive composition with the foamable polymer composition is preferred, other suitable methods such as spraying, immersion, or extrusion in a separate apparatus can also be used to apply the adhesive layer 22 to the dielectric layer 14 to form the adhesive coated core 56. Alternatively, the adhesive layer 22 can be provided on the inner surface of the outer conductor 18.

In order to produce low foam dielectric densities along the center conductor 12 of the cable 10, the method described above can be altered to provide a gradient or graduated density dielectric. For example, for a multilayer dielectric having a low density inner foam layer and a high density foam or solid outer layer, the polymer compositions forming the layers of the dielectric can be coextruded together and can further be coextruded with the adhesive composition forming adhesive layer 22. Alternatively, the dielectric layers can be extruded separately using successive extruder apparatus. Other suitable methods can also be used. For example, the temperature of the inner conductor 12 may be elevated to increase the size and therefore reduce the density of the cells along the inner conductor to form a dielectric having a radially increasing density.

After leaving the extruder apparatus 54, the adhesive coated core 56 is preferably cooled and then collected on a suitable container, such as reel 58, prior to being advanced to the manufacturing process illustrated in FIG. 4B. Alternatively, the adhesive coated core 56 can be continuously advanced to the manufacturing process of FIG. 4B without being collected on a reel 58.

As illustrated in FIG. 4B, the adhesive coated core 56 can be drawn from reel 58 and further processed to form the coaxial cable 10. A narrow elongate strip S, preferably formed of aluminum, from a suitable supply source such as reel 60 is directed around the advancing core 56 and bent into a generally cylindrical form by guide rolls 62 so as to loosely encircle the core to form a tubular sheath 18. Opposing longitudinal edges of the strip S can then be moved into abutting relation and the strip advanced through a welding apparatus 64 that forms a longitudinal weld 20 by joining the abutting edges of the strip S to form an electrically and mechanically continuous sheath 18 loosely surrounding the core 56. Alternatively, the strip S can be arranged such that the opposing longitudinal edges of the strip S overlap to form the electrically and mechanically continuous sheath 18.

Once the sheath 18 is longitudinally welded, the sheath can be formed into an oval configuration and weld flash scarfed from the sheath as set forth in U.S. Pat. No. 5,959,245, especially if a thin copper strip is being used to form the sheath. Alternatively, or after the scarfing process, the core 56 and surrounding sheath 18 advance directly through at least one sinking die 66 that sinks the sheath onto the core 56, thereby causing compression of the dielectric 14. A lubricant is preferably applied to the surface of the sheath 18 as it advances through the sinking die 66.

The cable advances from the sinking die 66 to a suitable extruder apparatus 68 for applying the adhesive composition of the invention to the outer surface of the sheath 18. Preferably, the adhesive composition is produced by feeding the polyethylene, the ethylene copolymer, the C5 hydrocarbon resin and any additional components to a feed hopper and into the extruder apparatus 68. The extruder apparatus 68 is operated at an elevated temperature (e.g. from about 375° F. to about 425° F.) and the components of the adhesive form a polymer melt in the extruder apparatus. The polymer melt is applied to the sheath 18 and allowed to cool to form the adhesive layer 26. The adhesive composition used to produce the adhesive layer 26 can also be applied by spraying or by other suitable means known in the art.

Once the adhesive layer 26 has been applied to the sheath 18, the cable is advanced to an additional extruder apparatus 70 and a polymer melt extruded concentrically around the sheath to produce the protective polymeric jacket 24. If multiple polymer layers are used to form the jacket 24, the polymer compositions forming the multiple layers may be coextruded together in surrounding relation to form the protective jacket. Additionally, a longitudinal tracer stripe of a polymer composition contrasting in color to the protective jacket 24 can be coextruded with the polymer composition forming the jacket for labeling purposes. Although FIG. 4 illustrates the use of two extruders 68 and 70 for the application of the adhesive layer 26 and the jacket 24, respectively, a single co-extruder can be used to apply these layers as would be understood by those skilled in the art.

The heat of the polymer melt that produces the jacket 24 activates the adhesive layer 22 between the sheath 18 and the dielectric layer 14 and the adhesive layer 26 between the jacket 24 and the sheath 18 to produce an adhesive bond between these layers. Once the protective jacket 24 has been applied, the coaxial cable is subsequently cooled to harden the jacket. The thus produced cable 10 can then be collected on a suitable container, such as a reel 72 for storage and shipment.

FIG. 5 illustrates the preferred method of making the coaxial cable 10 of FIGS. 2 and 3. As shown in FIG. 5, the center conductor 14 is advanced from a reel 80 along a predetermined path of travel (from left to right in FIG. 5). As mentioned above, to produce a coaxial cable having a continuous center conductor 14, the terminal edge of the center conductor from one reel is mated with the initial edge of the center conductor from a subsequent reel and welded together.

As the center conductor 14 advances, a suitable apparatus 82 such as an extruder apparatus or a spraying apparatus applies the thin polymeric layer 16. The coated center conductor then further advances to an extruder apparatus 84 that applies a polymer melt composition around the center conductor 12 and polymeric layer 16. As described above, the polymer melt composition is preferably a foamable polyethylene composition. Once the coated center conductor leaves the extruder apparatus 84, the polymer melt composition expands to form the dielectric layer 14. The center conductor 12, polymeric layer 16 and dielectric layer 14 form the cable core 86 of the cable 10. Once the cable core 86 leaves the extruder apparatus 84 and is properly cooled, it can then be continuously advanced through the process shown in FIG. 5 or can be collected on a reel before being further advanced through the process.

As shown in FIG. 5, as the cable core 86 advances, a shielding tape 30 is supplied from a reel 88 and is longitudinally wrapped or “cigarette-wrapped” around the cable core to form an electrically conductive shield. As mentioned above, the shielding tape 30 is preferably a bonded metal-polymer-metal laminate tape having an adhesive on one surface thereof. The shielding tape 30 is applied with the adhesive surface positioned adjacent the underlying cable core 86. If an adhesive layer is not already included on the shielding tape 30, an adhesive layer can be applied by suitable means such as extrusion or spraying prior to longitudinally wrapping the shielding tape around the cable core 86. One or more guiding rolls 90 direct the shielding tape 30 around the cable core 86 with longitudinal edges of the shielding tape preferably overlapping to provide a conductive shield having 100% shielding coverage of the cable core.

Once the shielding tape 30 is applied around the cable core 86, a braid 32 is preferably formed around the shielding tape 30 and combined with the shielding tape forms the outer conductor 18 of the cable 10. As shown schematically in FIG. 5, the braid 32 is formed by feeding a first plurality of aluminum wires 42 and a second plurality of aluminum wires 44 from a plurality of bobbins 92 and interlacing the wires to form the braid. Alternatively, a plurality of elongate aluminum wires 46 can be helically arranged or “served” around the shielding tape 30 instead of forming a braid 32 as illustrated in the embodiment of FIG. 3. In this embodiment, the elongate wires 46 drawn from the bobbins 92 are not interlaced to form a braid but are instead helically wound around the shielding tape 30. Although not illustrated in FIG. 3, an additional plurality of bobbins can be used to apply a second plurality of elongate wires around the first plurality of elongate strands 46, preferably having a helical orientation opposite that of the first plurality of elongate strands.

Once either the braid 32 has been formed around the shielding tape 30 or the elongate wires 46 are helically wound around the shielding tape 30 to form the outer conductor 18, an adhesive composition is applied to the outer conductor 18 to form the adhesive layer 26. Preferably, the cable is advanced to an extruder apparatus 94 and the adhesive composition is applied by the extruder apparatus as discussed above. In addition, the adhesive composition can be applied by spraying or by other suitable methods known in the art.

After the adhesive layer 26 has been applied, the cable is advanced to an extruder apparatus 96 and a polymer melt extruded at an elevated temperature (e.g. greater than about 250° F.) around the elongate strands to form the cable jacket 24. As mentioned above, the heat of the polymer melt activates the adhesive layers 22 and 26. The cable jacket 24 is allowed to cool and the completed cable 10 taken up on a reel 98 for storage and shipment.

The present invention will now be further described by the following non-limiting examples. All percentages are on a per weight basis unless otherwise indicated.

### EXAMPLES 1-3

Three adhesive compositions in accordance with the invention (Examples 1-3) and one conventional adhesive composition (Comparative Example 1) were prepared using the following components:

| | | | | Comparative |
|---|---|---|---|---|
| Components | Example 1 | Example 2 | Example 3 | Example 1 |
| Low density | 40.0% | 49.0% | 49.0% | 50.0% |
| polyethylene (LDPE) | | | | |
| PRIMACOR ® 3330 | 57.5% | 49.5% | 49.5% | 50.0% |
| (LDPE/EAA | | | | |
| copolymer blend) | | | | |
| WINGTACK ® Extra | 2.0% | 1.0% | | |
| WINGTACK ® 95 | | | 1.0% | |
| IRGANOX ® 1010 | 0.5% | 0.5% | 0.5% | |

A 1⅝ inch over-the-conductor diameter coaxial cable (as illustrated in FIG. 1) meeting the specifications of CommScope's CELL REACH® 50-1873 cable was prepared according to the method illustrated in FIG. 4 with a copper inner conductor, a closed cell foam polyethylene dielectric, a smooth-walled copper sheath and a polyethylene jacket. The inner conductor was bonded to the dielectric and the dielectric was bonded to the copper sheath using a conventional LDPE/EAA adhesive. The copper sheath was bonded to the jacket using the adhesive compositions described above. The adhesive was prepared by adding the ingredients to an extruder apparatus at a temperature of 400° F. and extruding the resulting adhesive composition around the copper sheath prior to application of the polymer jacket.

The coaxial cable prepared using the adhesive of Example 1 and the coaxial cable prepared using the adhesive composition of Comparative Example 1 were subjected to the tests below with the following results.

| | Comparative | |
|---|---|---|
| Test | Example 1 | Example 1 |
| Green Peel Strength¹ | 6.21 lb_{f}/in AF² | 29.20 lb_{f}/in AF |
| 72 Hour Peel Strength³ | 4.80 lb_{f}/in AF | 13.64 lb_{f}/in AF |
| One Week Reverse Bend (To Wrinkle)⁴ | 13 bends | 19 bends |
| One Week Reverse Bend (To Buckle)⁵ | 16 bends | 25 bends |
| One Week Jacket Removal⁶ | 40% CF⁷ | AF (very clean) |

¹The green peel strength was measured at peak load about 30 minutes after the cable was produced using a modified version of ASTM method D 3330 at a pull rate of 2 inches/min instead of the 12 inches/min.
²AF means adhesive failure with a thin layer of adhesive residue on the conductor surface that can be easily removed.
³The 72 hour peel strength was measured 72 hours after the cable was produced using the modified version of ASTM method D 3330 described above in footnote 1. The 72 hour peel strength was measured after the peak load when peeling was initiated and represented the load necessary to continue peeling the jacket from the outer conductor.
⁴The one week reverse bend (to wrinkle) was measured by determining the number of reverse bends the cable could sustain on a 44 inch diameter mandrel without wrinkling.
⁵The one week reverse bend (to buckle) was measured by determining the number of reverse bends the cable could sustain on a 44 inch diameter mandrel without buckling.
⁶The one week jacket removal was measured using a modified version of ASTM method D 3330 at a pull rate of 2 inches/min.
⁷CF means cohesive failure with difficult to remove adhesive residue (provided as a percentage) over the conductor surface.

As shown in the above tests, the adhesive of the invention when used to bond a polymeric jacket to a metal outer conductor possesses increased bond strength over conventional LDPE/EAA adhesives. For example, the green peel strength for 1⅝ inch coaxial cable is preferably at least about 7 lb_{f}/in to adhesive failure, and more preferably at least about 14 lb_{f}/in. Moreover, the 72 hour peel strength for 1⅝ inch coaxial cable is preferably at least about 5 lb_{f}/in to adhesive failure, and more preferably at least about 12 lb_{f}/in.

Furthermore, the adhesive of the invention produces a coaxial cable having improved bending properties over coaxial cable using conventional LDPE/EAA adhesives. For example, when the adhesive composition of the invention is used in a coaxial cable, the one week reverse bend is typically at least 15 bends to wrinkle and more preferably at least 20 bends to wrinkle.

It is understood that upon reading the above description of the present invention and reviewing the accompanying drawings, one skilled in the art could make changes and variations therefrom. These changes and variations are included in the spirit and scope of the following appended claims.

That which is claimed:

1. An adhesive, comprising:
polyethylene;
a copolymer derived from ethylene and at least one monomer selected from the group consisting of acrylic acid, methacrylic acid, methyl acrylate and ethyl acrylate; and
a resin derived from at least one unsaturated C5 hydrocarbon monomer.

2. The adhesive according to claim 1, further comprising a hindered phenolic antioxidant.

3. The adhesive according to claim 1, wherein the resin is a C5 hydrocarbon resin derived from at least one monomer selected from the group consisting of piperylene, 2-methyl-2-butene, isoprene, cyclopentene, cyclopentadiene, and dimers thereof.

4. The adhesive according to claim 3, wherein the C5 hydrocarbon resin is further derived from at least one aromatic monomer.

5. The adhesive according to claim 3, wherein the C5 hydrocarbon resin is further derived from α-methyl styrene.

6. The adhesive according to claim 1, wherein the C5 hydrocarbon resin is derived from aliphatic monomers.

7. The adhesive according to claim 1, wherein the polyethylene includes a low density polyethylene.

8. The adhesive according to claim 1, wherein the copolymer is an ethylene-acrylic acid copolymer.

9. The adhesive according to claim 1, wherein the polyethylene is present in an amount from about 80 to about 95 percent by weight, the copolymer is present in an amount from about 3 to about 5 percent by weight, the resin is present in an amount from about 0.2 to about 15 percent by weight, and an hindered phenolic antioxidant is present in an amount from 0 to about 1.0 percent by weight.

10. The adhesive according to claim 1, wherein the polyethylene is present in an amount from about 90 to about 95 percent by weight, the copolymer is present in an amount from about 3 to about 5 percent by weight, the resin is present in an amount from about 1 to about 5 percent by weight, and an hindered phenolic antioxidant is present in an amount from 0.2 to about 0.8 percent by weight.

11. An adhesive, comprising:
low density polyethylene;
an ethylene-acrylic acid copolymer;
a C5 hydrocarbon resin derived from at least one monomer selected from the group consisting of piperylene, 2-methyl-2-butene, isoprene, cyclopentene, cyclopentadiene, and dimers thereof; and
a hindered phenolic antioxidant.

12. The adhesive according to claim 11, wherein the C5 hydrocarbon resin is further derived from α-methyl styrene.

13. A cable, comprising:
a metal conductor;
a polymeric jacket surrounding said metal conductor; and
an adhesive bonding said outer conductor and said polymer jacket, said
adhesive comprising polyethylene; a copolymer derived from ethylene and at least one monomer selected from the group consisting of acrylic acid, methacrylic acid, methyl acrylate and ethyl acrylate; and a resin derived from at least one unsaturated C5 hydrocarbon monomer.

14. The cable according to claim 13, wherein said adhesive further comprises a hindered phenolic antioxidant.

15. The cable according to claim 13, wherein the resin in said adhesive is derived from at least one monomer selected from the group consisting of piperylene, 2-methyl-2-butene, isoprene, cyclopentene, cyclopentadiene, and dimers thereof.

16. The cable according to claim 15, wherein the resin in said adhesive is further derived from at least one aromatic monomer.

17. The cable according to claim 15, wherein the resin in said adhesive is further derived from α-methyl styrene.

18. The cable according to claim 13, wherein the resin in said adhesive is derived from aliphatic monomers.

19. The cable according to claim 13, wherein the polyethylene in said adhesive includes a low density polyethylene.

20. The cable according to claim 13, wherein the copolymer in said adhesive is an ethylene-acrylic acid copolymer.

21. The cable according to claim 13, wherein the polyethylene is present in an amount from about 80 to about 95 percent by weight, the copolymer is present in an amount from about 3 to about 5 percent by weight, the resin is present in an amount from about 0.2 to about 15 percent by weight, and an hindered phenolic antioxidant is present in an amount from 0 to about 1.0 percent by weight.

22. The cable according to claim 13, wherein the polyethylene is present in an amount from about 90 to about 95 percent by weight, the copolymer is present in an amount from about 3 to about 5 percent by weight, the resin is present in an amount from about 1 to about 5 percent by weight, and an hindered phenolic antioxidant is present in an amount from 0.2 to about 0.8 percent by weight.

23. The cable according to claim 13, wherein the metal conductor is formed of copper or a copper alloy.

24. The cable according to claim 13, wherein the polymeric jacket is formed of polyethylene.

25. The cable according to claim 13, wherein the adhesive forms an adhesive bond between said outer conductor and said polymeric jacket having a 72 hour bond peel strength of at least about 5 lb_{f}/in.

26. The cable according to claim 13, further comprising an inner conductor and a dielectric layer surrounding said inner conductor, wherein said metal conductor is an outer conductor and surrounds said dielectric layer.

27. A coaxial cable, comprising:
an inner conductor;
a dielectric layer surrounding said inner conductor;
an outer conductor formed of copper or a copper alloy surrounding said dielectric layer;
a polymeric jacket formed of polyethylene surrounding said outer conductor; and
an adhesive bonding said outer conductor and said polymer jacket, said adhesive comprising about 80 to about 95 percent by weight polyethylene; about 3 to about 5 percent by weight ethylene-acrylic acid copolymer, about 0.2 to about 15 percent by weight of a resin derived from at least one unsaturated C5 hydrocarbon monomer, and from 0 to about 1.0 percent by weight of a hindered phenolic antioxidant.

28. The coaxial cable according to claim 27, wherein the adhesive forms an adhesive bond between said outer conductor and said polymeric jacket having a 72 hour bond peel strength of at least about 5 lb_{f}/in.
